(19) United States
(12) Patent Application Publication
(10) Pub. No.: US 2023/0066929 A1
(43) Pub. Date: Mar. 2, 2023

(54) Dynamic Workspace Connectivity Management

(71) Applicant: Dell Products L.P., Round Rock, TX (US)

(72) Inventors: Vivek Viswanathan Iyer, Austin, TX (US); Harpreet S. Narula, Austin, TX (US)

(73) Assignee: Dell Products L.P., Round Rock, TX (US)

(21) Appl. No.: 17/462,096

(22) Filed: Aug. 31, 2021

(51) Int. Cl. G06F 9/455; H04L 29/08

(52) U.S. Cl. CPC G06F 9/45558; H04L 67/141; G06F 2009/45595

(57) ABSTRACT

A system, method, and computer-readable medium are disclosed for performing an intelligent connectivity operation. The intelligent connectivity operation includes: implementing a first hybrid container environment on a first user device, the first hybrid container environment comprising a plurality of first hybrid container environment workspaces; implementing a second hybrid container environment on a second user device, the second hybrid container environment comprising a plurality of second hybrid container environment workspaces; and, performing a dynamic workspace connectivity management operation, the dynamic workspace connectivity management operation managing connectivity between one of the plurality of first hybrid container environment workspaces and one of the plurality of second hybrid container environment workspaces.

### BACKGROUND OF THE INVENTION

### Field of the Invention

The present invention relates to information handling systems. More specifically, embodiments of the invention relate to performing a network traffic routing operation.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

### SUMMARY OF THE INVENTION

In one embodiment the invention relates to a method for performing an intelligent connectivity operation, comprising: implementing a first hybrid container environment on a first user device, the first hybrid container environment comprising a plurality of first hybrid container environment workspaces; implementing a second hybrid container environment on a second user device, the second hybrid container environment comprising a plurality of second hybrid container environment workspaces; and, performing a dynamic workspace connectivity management operation, the dynamic workspace connectivity management operation managing connectivity between one of the plurality of first hybrid container environment workspaces and one of the plurality of second hybrid container environment workspaces.

In another embodiment the invention relates to a system comprising: a processor; a data bus coupled to the processor; and a non-transitory, computer-readable storage medium embodying computer program code, the non-transitory, computer-readable storage medium being coupled to the data bus, the computer program code interacting with a plurality of computer operations and comprising instructions executable by the processor and configured for: implementing a first hybrid container environment on a first user device, the first hybrid container environment comprising a plurality of first hybrid container environment workspaces; connecting the first hybrid container environment with a second hybrid container environment on a second user device, the second hybrid container environment comprising a plurality of second hybrid container environment workspaces; and, performing a dynamic workspace connectivity management operation, the dynamic workspace connectivity management operation managing connectivity between one of the plurality of first hybrid container environment workspaces and one of the plurality of second hybrid container environment workspaces.

In another embodiment the invention relates to a computer-readable storage medium embodying computer program code, the computer program code comprising computer executable instructions configured for: implementing a first hybrid container environment on a first user device, the first hybrid container environment comprising a plurality of first hybrid container environment workspaces; implementing a second hybrid container environment on a second user device, the second hybrid container environment comprising a plurality of second hybrid container environment workspaces; and, performing a dynamic workspace connectivity management operation, the dynamic workspace connectivity management operation managing connectivity between one of the plurality of first hybrid container environment workspaces and one of the plurality of second hybrid container environment workspaces.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a general illustration of components of an information handling system as implemented in the system and method of the present invention.

FIG. 2 is a block diagram of an intelligent connectivity environment;

FIG. 3 shows a simplified block diagram of a hybrid container environment;

FIGS. 4a and 4b are a simplified block diagram showing hardware and software components of a dynamic workspace connectivity environment;

FIG. 5 shows a simplified block diagram of the performance of dynamic workspace connectivity management operations; and

FIGS. 6a and 6b show process flows associated with the performance of dynamic workspace connectivity management operations.

### DETAILED DESCRIPTION

A system, method, and computer-readable medium are disclosed for performing a dynamic workspace connectivity management operation. Certain aspects of the invention reflect an appreciation that there is an increasing need to efficiently and securely get data from where it may be stored or generated to where it is needed, whether that be in a data center, in the cloud, on the network edge, or a combination thereof Certain aspects of the invention likewise reflect an appreciation that there is a growing proliferation of network-enabled devices and network connectivity options. These network connectivity options include Personal Area Networks (PANs), such as Bluetooth, Wireless Local Area Networks (WLANs), such as Wireless Fidelity (WiFi) networks, Wireless Wide Area Networks (WWANs), such as 3G, 4G, and 5G cellular networks, satellite networks, and wired networks, such as traditional LANs, and Wide Area Networks (WANs), such as the Internet.

Certain aspects of the invention reflect an appreciation that today's network-enabled productivity, collaboration, work, and entertainment activities are increasingly occurring anywhere and at any time. Likewise, certain aspects of the invention reflect an appreciation that such activities are becoming a part of everyday life, and as a result, are leading to an increased expectation of network connectivity wherever and whenever needed. Certain aspects of the invention reflect an appreciation that users have likewise come to expect network connectivity, regardless of the underlying technology used to provide it, to be seamless, reliable, and secure.

Certain aspects of the invention reflect an appreciation that various approaches are known for managing peer-to-peer communication. However, such approaches are typically not oriented to providing network connectivity optimization and advanced security through workspace isolation. Certain aspects of the invention likewise reflect an appreciation that known wireless dock approaches may provide basic Quality of Service (QoS) and bandwidth optimization. However, such approaches do not support containerized isolation of workspaces.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

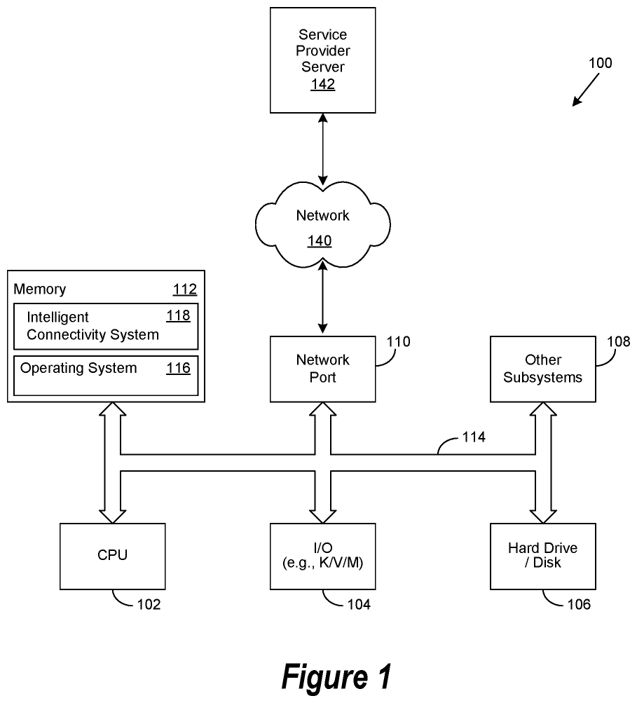

FIG. 1 is a generalized illustration of an information handling system 100 that can be used to implement the system and method of the present invention. The information handling system 100 includes a processor (e.g., central processor unit or “CPU”) 102, input/output (I/O) devices 104, such as a display, a keyboard, a mouse, a touchpad or touchscreen, and associated controllers, a hard drive or disk storage 106, and various other subsystems 108. In various embodiments, the information handling system 100 also includes network port 110 operable to connect to a network 140, which is likewise accessible by a service provider server 142. The information handling system 100 likewise includes system memory 112, which is interconnected to the foregoing via one or more buses 114. System memory 112 further comprises operating system (OS) 116 and in various embodiments may also comprise an intelligent connectivity system 118. In one embodiment, the information handling system 100 is able to download the intelligent connectivity system 118 from the service provider server 142. In another embodiment, the intelligent connectivity system 118 is provided as a service from the service provider server 142.

In certain embodiments, the intelligent connectivity system 118 may be implemented to perform a dynamic workspace connectivity management operation, described in greater detail herein. In certain embodiments, the dynamic workspace connectivity management operation may be performed by the intelligent connectivity system 118 during operation of an information handling system 100. In certain embodiments, the performance of the dynamic workspace connectivity management operation may result in the realization of improved and more secure network connectivity for the information handling system 100 and its associated workspaces, as described in greater detail herein.

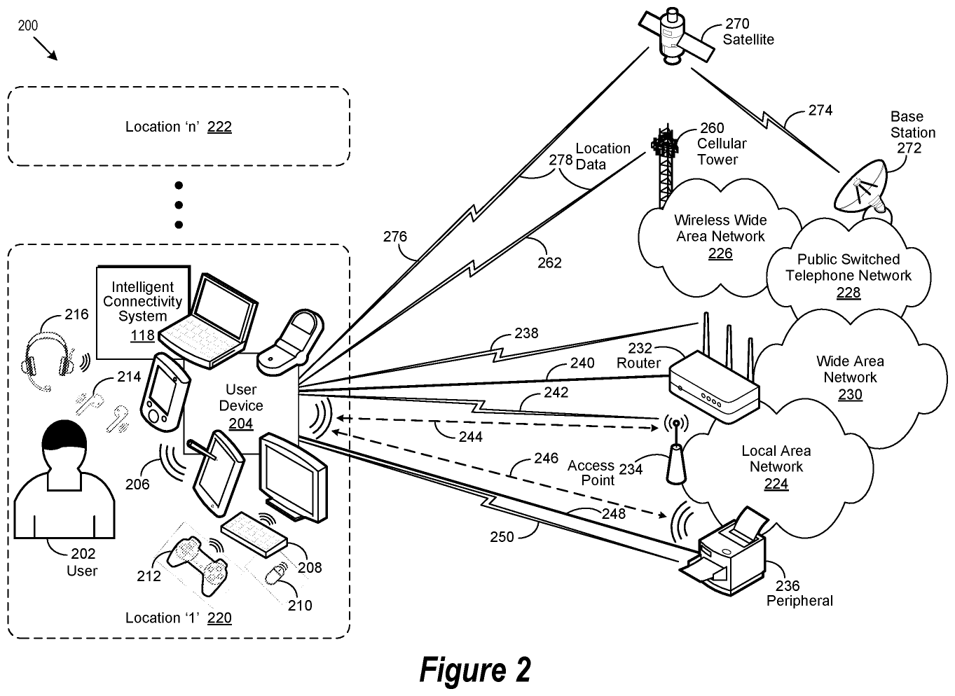

FIG. 2 is a block diagram of an intelligent connectivity environment implemented in accordance with an embodiment of the invention. In certain embodiments, the intelligent connectivity environment 200 may include an intelligent connectivity system 118, described in greater detail herein. In certain embodiments, the intelligent connectivity system 118 may be implemented on a user device 204. As used herein, a user device 204 broadly refers to an information handling system such as a personal computer, a laptop computer, a tablet computer, a personal digital assistant (PDA), a smart phone, a mobile telephone, or other device that is capable of communicating and processing data. In certain embodiments, a user 202 may use the user device 204 to interact with the intelligent connectivity system 118.

In certain embodiments, the intelligent connectivity environment 200 may include a Local Area Network (LAN) 224, a Personal Area Network (PAN) 206, a Wireless Local Area Network (WLAN), a Wireless Wide Area Network (WWAN) 226, a satellite 270 network, the public switched telephone network (PSTN) 228, and a Wide Area Network (WAN) 230, such as the Internet, or a combination thereof. In certain embodiments, the LAN 224 may be based upon one or more protocols, such as Ethernet, Asynchronous Transfer Mode (ATM), Token Ring, or Fiber Distributed Data Interface (FDDI). In certain embodiments, the PAN 206 may be based upon one or more protocols commonly associated with Bluetooth, ZigBee, or ultrawideband (UWB). In certain embodiments, the WLAN may be based upon one or more variants of the IEEE 802.11 wireless communication standard. In certain embodiments, the WWAN 226 may be based upon one or more generations of known cellular network protocols, commonly referred to as 3G, 4G, 5G, and so forth. In certain embodiments, the WAN 230 may be based upon one or more protocols, such as X.25, Frame Relay, Asynchronous Transfer Mode (ATM), or Telecommunications Protocol/Internet Protocol (TCP/IP).

In certain embodiments, the user device 204 may be implemented with communication hardware and software that allows it to communicate with one or more wirelessly-enabled input/output (I/O) devices via a PAN 206 network link. Examples of such wirelessly-enabled I/O devices include a keyboard 208, a mouse 210, a game controller 212, earphones or earbuds 214, a headset 216, and so forth. Skilled practitioners of the art will be familiar with a network link, which as commonly used, refers to the physical and logical network component used to interconnect hosts or nodes in a network. Those of skill in the art will likewise be aware that such network links are generally established through the link layer of a telecommunications protocol stack, such as the Internet protocol suite or the Open Systems Interconnection (OSI) model. As typically implemented, the link layer refers to a group of methods and communications protocols confined to the network link that a host, such as a particular user device 204 is physically connected to.

In certain embodiments, the user device 204 may be implemented with communication hardware and software that allows it to communicate with one or more access points 234 via a PAN 242 network link, or a WLAN 244 network link, or both. Skilled practitioners of the art will be familiar with a wireless access point (AP) 234, which generally refers to a networking hardware device that allows a wirelessly-enabled device, such as a particular user device 204, to connect to a wired network, such as a LAN 224. In various embodiments, the AP 234 may be implemented as a stand-alone device. In certain of these embodiments, the AP 234 may be implemented to connect to a router 232 through a LAN 224. In certain embodiments, the functionality of an AP 234 may be implemented as an integral component of the router 232.

In certain embodiments, the user device 204 may be implemented with communication hardware and software that allows it to communicate with one or more peripherals 236 via a PAN 246 network link, a LAN 248 network link, or a WLAN 250 network link, or a combination thereof. In certain embodiments, the user device 204 may be implemented with communication hardware and software that allows it to communicate with one or more routers 232 via a LAN 240 network link, or a WLAN 238 network link, or both. In certain embodiments, the user device 204 may be implemented with communication hardware and software that allows it to communicate with one or more WWAN 226 cellular towers 260 via a WWAN 262 network link. In certain embodiments, the user device 204 may be implemented with communication hardware and software that allows it to communicate with one or more satellites 270 via a satellite 276 network link.

In various embodiments, a particular cellular tower 260, or a particular satellite 270, or a combination of the two, may be implemented, individually or in combination, to provide certain location data 278, familiar to those of skill in the art, to the user device 204. In certain embodiments, the user device 204 may be configured to receive such location data 278, which is used as a data source for determining the user device's 204 location ‘1’ 220 through ‘n’ 222. In certain embodiments, the location data 278 may include Global Position System (GPS) data provided by a GPS satellite 270. In certain embodiments (not shown), the location data 278 may include various Internet Protocol (IP) or other network address information assigned to the user device 204. In certain embodiments (not shown), the location data 278 may likewise be provided by a router 232, or an AP 234, or both.

In certain embodiments, one or more satellites 270 may be implemented to use known satellite communication protocols to establish a satellite network link 274 to a base station 272. In various embodiments, the base station 272 may in turn be implemented to be connected to the PSTN 228, which in certain embodiments may likewise be implemented to be connected to one or more WWANs 230, or one or more WANs 230, or a combination thereof. In various embodiments, one or more LANs 224 may be implemented to be connected to one or more WANs 230, or a combination thereof. In certain of these embodiments, one or more routers 232, may be implemented, individually or in combination, to connect a particular LAN 224 to a particular WAN 230.

In various embodiments, the intelligent connectivity system 118 may be implemented to establish a particular network link 206, 238, 240, 242, 244, 246, 248, 250, 262, 276 as the user device 204 moves from location ‘1’ 220 to location ‘n’ 222. In certain of these embodiments, the establishment of a particular network link 206, 238, 240, 242, 244, 246, 248, 250, 262, 276 may be based upon the availability of connectivity to a corresponding network. In various embodiments, the intelligent connectivity system 118 may be implemented to switch from one network link 206, 238, 240, 242, 244, 246, 248, 250, 262, 276 to another. In certain of these embodiments, such switching may be based upon the respective signal strength, available bandwidth, network latency, or a combination thereof, associated with the availability of connectivity to a corresponding network.

In certain embodiments, the intelligent connectivity system 118 may be implemented to switch from one network link 206, 238, 240, 242, 244, 246, 248, 250, 262, 276 to another according to the user device 204 being present at a particular location ‘1’ 220 through ‘n’ 222. In various embodiments, the intelligent connectivity system 118 may be implemented to establish two or more simultaneous network links 206, 238, 240, 242, 244, 246, 248, 250, 262, and 276. In certain of these embodiments, bandwidth respectively corresponding to the two or more network links 206, 238, 240, 242, 244, 246, 248, 250, 262, and 276 may be combined to provide aggregated network link bandwidth for use by the user device.

In various embodiments, the intelligent connectivity system 118 may be implemented to assign network connectivity corresponding to a particular software application, or a user device 204 process, to a particular network link 206, 238, 240, 242, 244, 246, 248, 250, 262, 276. In certain embodiments, the intelligent connectivity system 118 may be implemented to respectively assign two or more software applications, or user device 204 processes, to two or more network links 206, 238, 240, 242, 244, 246, 248, 250, 262, and 276 according to their corresponding attributes. For example, the intelligent connectivity system 118 may be implemented to assign a wireless-enabled gaming controller 212 to a PAN 206 link, while information generated and received by a game executing on the user device 204 may be assigned to WLAN 238 network link.

In certain of these embodiments, the respective assignment of two or more software applications, or user device 204 processes, or a combination thereof, to two or more network links 206, 238, 240, 242, 244, 246, 248, 250, 262, 276 may be according to the user device 204 being present at a particular location ‘1’ 220 through ‘n’ 222. As an example, only a lower-speed (e.g., 300 Mbps) WLAN 238 network link may be available at location ‘1’ 220, but both a high-speed (e.g., 100 Gbps) LAN 240 network link and a higher-speed (e.g., 1.7 Gbps) WLAN 238 network link may be available at location ‘n’ 222. In this example, the user 202 may wish to play a particular online game while simultaneously conducting an online chat session, whether they are at location ‘1’ 220 or ‘n’ 222. To continue the example, it is possible that the bandwidth of the WLAN 238 network link at location ‘1’ 220 may be barely adequate to support the network connectivity needs of the on-line game. As a result, the additional overhead of network traffic associated with the online chat session may result in the game not performing as responsively as desired.

However, the intelligent connectivity system 118 may be implemented to respectively assign the online chat session to the higher-speed WLAN 238 network link and the online game to the high-speed LAN 240 network link available at location ‘n’ 222. Accordingly, responsiveness of the online game will likely be improved due to the 100 Gbps speed provided by the LAN 238 network link available at location ‘n’ 220, while the online chat session will be adequately supported by the 1.7 Gbps speed of the WLAN 240 network link. Skilled practitioners of the art will recognize that many such embodiments and examples are possible. Accordingly, the foregoing is not intended to limit the spirit, scope or intent of the invention.

In certain embodiments, the intelligent connectivity system 118 may be implemented to establish and manage one or more virtual private network (VPN) connections on one or more corresponding network links. Skilled practitioners of the art will be familiar with a VPN, which as typically implemented, uses known tunneling protocols to extend a private network, such as a private LAN 224, across a public WAN 230, such as the Internet, to enable users 202 to use their user devices 204 to send and receive data to and from an external resource, such as a remote server, as if it was directly connected to the private network. Certain embodiments of the invention reflect an appreciation that a single VPN may not always be sufficient for a particular operational mode. Accordingly, in certain embodiments, the intelligent connectivity system 118 may likewise be implemented to perform a multi-link network traffic routing operation. As used herein, a multi-link traffic routing operation broadly refers to any operation performed to route network traffic across two or more network links.

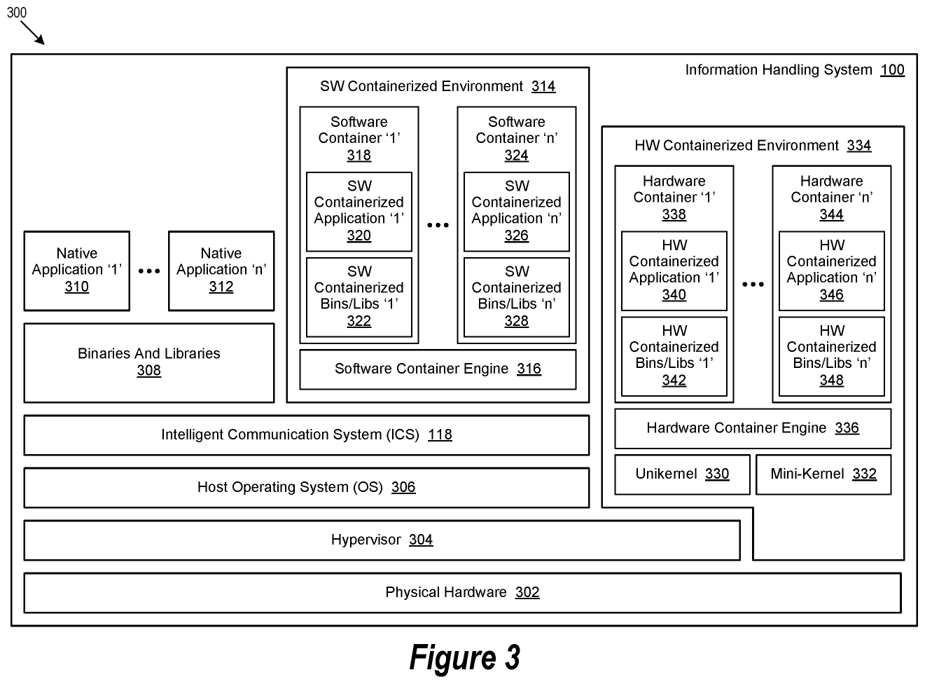

FIG. 3 shows a simplified block diagram of a hybrid container environment implemented in accordance with an embodiment of the invention. Skilled practitioners of the art will be familiar with the concept of a container, which as typically implemented is a virtualized runtime environment whose components include an application and the executables, binaries, libraries, and configuration files needed to run it. In certain embodiments, the functionality of an application executing within a container may be provided as a service, familiar to those of skill in the art. Certain embodiments of the invention reflect an appreciation that such containerization of an application and its dependencies allows differences in operating system (OS) distributions and underlying infrastructures to be abstracted such that the application can run on any host system.

Likewise, certain embodiments of the invention reflect an appreciation that a container is also granted its own isolated portion of an information handling system's 100 compute, memory, storage, and input/output (I/O) resources at runtime. Certain embodiments of the invention likewise reflect an appreciation that an individual container may be implemented to run anything from a small microservice, to a software process, to a complex software application.

In various embodiments, the hybrid container environment 300 may be implemented on an information handling system (IHS) 100, described in greater detail herein. In certain embodiments, the IHS 100 may be implemented to include certain physical hardware 302, a hypervisor 304, a host operating system (OS) 306, and an intelligent communication system (ICS) 118, likewise described in greater detail herein. In certain of these embodiments, the hypervisor 304 may be implemented to support the host OS 306, a unikernel 330, or a mini-kernel 332, or a combination thereof.

In various embodiments, the host OS 306 may be implemented to support the ICS 118, one or more binaries or libraries 308, or a software (SW) containerized environment 314, or a combination thereof. In certain embodiments, the ICS 118 may be implemented to perform a dynamic workspace connectivity management operation. As used herein, a dynamic workspace connectivity management operation broadly refers to any operation whose performance results in improved and more secure network connectivity for the IHS 100 and its associated workspaces. As likewise used herein, a workspace broadly refers to one or more workloads, applications, processes, or services, or a combination thereof.

In certain embodiments, a particular workspace may be implemented to run as an individual native application ‘1’ 310 through ‘n’ 312, in an individual SW container ‘1’ 318 through ‘n’ 324, or in an individual HW container ‘1’ 338 through ‘n’ 344. In certain embodiments, the workspace may be implemented to run in a cloud environment, or on an endpoint IHS 100, or a combination of the two. In certain embodiments, the one or more binaries or libraries 308 may in turn be implemented to support one or more native applications ‘1’ 310 through ‘n’ 312. In certain embodiments, the unikernel 330 or mini-kernel 332 may individually be implemented to support a particular hardware (HW) containerized environment 334. Skilled practitioners of the art will be familiar with a unikernel 330, which is a specialized, single address space machine image constructed by using library operating systems. In typical implementations, a developer selects, from a modular stack, the minimal set of libraries corresponding to the OS constructs needed for a particular application to run.

These libraries are then compiled with the application and its dependencies code to build sealed, fixed-purpose images (i.e., unikernels), which run directly on a hypervisor 304 or physical hardware 302 without an intervening host OS 306 such as Linux™ or Windows™. Those of skill in the art will likewise be familiar with a mini-kernel 332, often referred to as a microkernel, which is the near-minimum amount of software that can provide the mechanisms needed to implement an OS. In certain embodiments, such mechanisms may include low-level address space management, thread management, and inter-process communication (IPC). In certain embodiments, a mini-kernel 332 may be used by the HW container engine 336 to generate one or more HW containers ‘1’ 338 through ‘n’ 334 that can be implemented to run directly on a hypervisor 304 or physical hardware 302 without an intervening host OS 306.

As used herein, a containerized environment, such as the SW containerized environment 314 and the HW containerized environment 330 shown in FIG. 3, broadly refers to a computing environment in which applications may be run in containers. In certain embodiments, such a containerized environment may be implemented to include a single type of container or multiple types of containers. In certain embodiments, the containerized environment may be implemented to exist on an end user computing device or on a server computing device.

In various embodiments, the SW containerized environment 314 may be implemented to include a SW container engine 316. In certain of these embodiments, the SW container engine 316 may be implemented to generate and manage one or more SW containers ‘1’ 318 through ‘n’ 324. Examples of such SW containers include DOCKER™ and SNAP™ containers. In certain embodiments, the one or more SW containers ‘1’ 318 through ‘n’ 324 may likewise be implemented to respectively include SW containerized applications ‘1’ 320 though ‘n’ 326 and their associated binaries and libraries ‘1’ 322 through ‘n’ 328. In certain embodiments, the one or more SW containers ‘1’ 318 through ‘n’ 324 may be distributed from a trusted source.

Likewise, in various embodiments, the HW containerized environment 334 may be implemented to include a HW container engine 336. In certain of these embodiments, the HW container engine 336 may be implemented to use either a unikernel 330 or a mini-kernel 332 to generate and manage one or more HW containers ‘1’ 338 through ‘n’ 344. Examples of such HW containers include Hyper-V DOCKER™ and Intel CLEAR™ containers.

In certain embodiments, the one or more HW containers ‘1’ 338 through ‘n’ 344 may likewise be implemented to respectively include HW containerized applications ‘1’ 340 though ‘n’ 346 and their associated binaries and libraries ‘1’ 342 through ‘n’ 348. In certain embodiments, the one or more HW containers ‘1’ 338 through ‘n’ 344 may be distributed from an untrusted source. Certain embodiments of the invention reflect an appreciation that HW containers typically require higher operational overhead than their SW container peers, but provide better isolation from the hypervisor 304, and hence, better security.

In various environments, a SW containerized environment 314 or a HW containerized environment 364 may be implemented to isolate a particular containerized application from native applications and other containerized applications. As an example, the HW containerized environment 364 may be implemented to isolate HW containerized application ‘1’ 340 from native applications ‘1’ 310 through ‘n’ 312 and SW containerized applications ‘1’ 320 through ‘n’ 326. To continue the example, the SW containerized environment 314 may be implemented to isolate SW containerized application ‘1’ 320 from native applications ‘1’ 310 through ‘n’ 312 and HW containerized applications ‘1’ 340 through ‘n’ 346

In various embodiments, SW containers ‘1’ 318 through ‘n’ 324, or HW containers ‘1’ 338 through ‘n’ 344, or a combination thereof, may be implemented to run in a cloud environment. In certain of these embodiments, the SW containers ‘1’ 318 through ‘n’ 324, or HW containers ‘1’ 338 through ‘n’ 344, or a combination thereof, may be implemented to be served up to a client through a web apps orchestration layer familiar to skilled practitioners of the art. In certain embodiments, the SW containers ‘1’ 318 through ‘n’ 324, or HW containers ‘1’ 338 through ‘n’ 344, or a combination thereof, may be implemented to be served up to a client through a Virtual Desktop Infrastructure (VDI) or in the form of a Progressive Web App (PWA).

Certain embodiments of the invention reflect an appreciation that it is becoming more common for organizations to use containerization solutions. Likewise, certain embodiments of the invention reflect an appreciation that containerization allows applications and services to be implemented on a cloud-based management server or other centralized repository as opposed to being installed on end-user devices. Various embodiments of the invention likewise reflect an appreciation that while containerization provides certain benefits, it also introduces a number of limitations.

For example, if a containerized application needs access to a peripheral, the peripheral will need to be mapped to the container in which the application in hosted. However, doing so may prevent other applications that are not hosted in the same container from accessing the peripheral. As an example, if a printer is mapped to SW container ‘1’ 318, SW containerized application 320 may be able to access the printer, but SW containerized application ‘n’ 326 and HW containerized applications ‘1’ 340 through ‘n’ 346 may not.

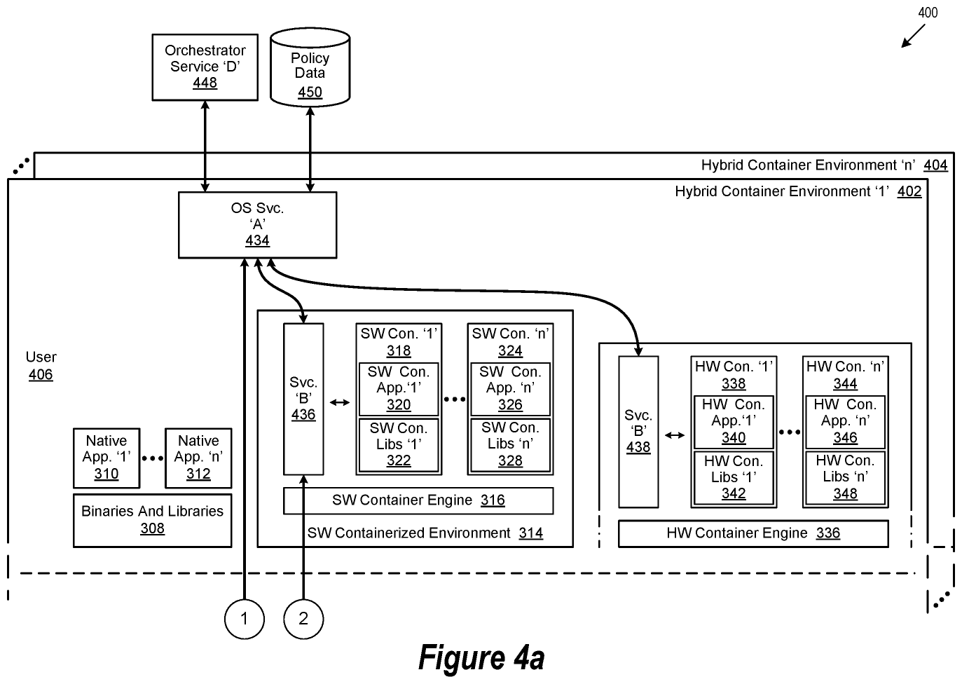

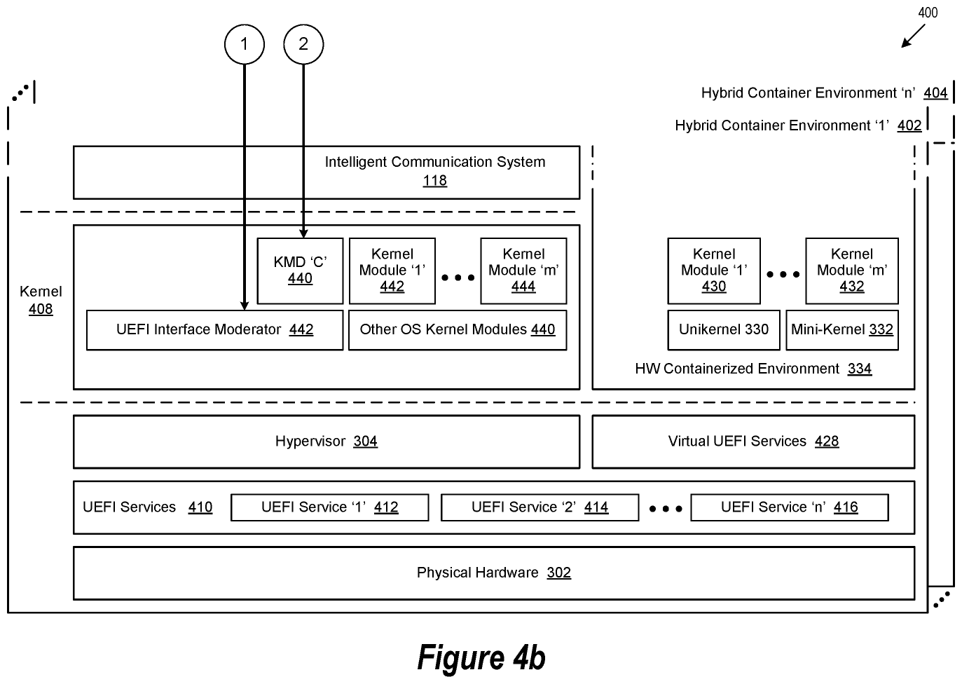

FIGS. 4a and 4 b are a simplified block diagram showing a dynamic workspace connectivity management environment implemented in accordance with an embodiment of the invention. In certain embodiments, one or more hybrid container environments ‘1’ 402 through ‘n’ 404, described in greater detail herein, may be implemented to create a dynamic workspace connectivity management environment 400. In certain embodiments, the dynamic workspace connectivity management environment 400 may be implemented, as described in greater detail herein, to manage the network connectivity and security of one or more workspaces, likewise described in greater detail herein.

In various embodiments, one or more hybrid container environments ‘1’ 402 through ‘n’ 404, described in greater detail herein, may be implemented to create a dynamic workspace connectivity management environment 400. In various embodiments, each of the hybrid container environments ‘1’ 402 through ‘n’ 404 may be implemented to include certain physical hardware 302, certain Unified Extensible Firmware Interface (UEFI) services 410, such as UEFI services ‘1’ 412, and ‘2’ 414 through ‘n’ 416, a hypervisor 304 and certain virtual UEFI services 428. In various embodiments, each of the hybrid container environments ‘1’ 402 through ‘n’ 404 may likewise be implemented to include a user portion 406 and a kernel portion 408, familiar to skilled practitioners of the art. In certain embodiments, the kernel portion may be implemented to include software (SW) service ‘C’ 440, a UEFI interface moderator, and one or more other operating system (OS) kernel modules 440, such as kernel modules ‘1’ 442 through ‘n’ 440.

In certain embodiments, SW services ‘A’ 442 and ‘B’ 432, 436 may be implemented, as described in greater detail herein, within each hybrid container environments ‘1’ 402 through ‘n’ 404. In certain embodiments, SW service ‘D’ 440 may be implemented to serve as a manageability and security control point to configure individual workspaces associated with each hybrid container environment ‘1’ 402 through ‘n’ 404. In certain embodiments, SW service ‘D’ 440 may be implemented as a workspace connectivity management orchestrator. In certain embodiments, SW service ‘D’ 440 may be implemented as a web service within a cloud environment.

In certain embodiments, an intelligent connectivity system (ICS) 118 implemented within a particular hybrid container service ‘1’ 402 through ‘n’ 404 may likewise be implemented to use software (SW) services ‘A’ 442, ‘B’ 432, 436, and ‘C’ 414 implemented within the same hybrid container service in combination with SW service ‘D’ 448 to perform a dynamic workspace connectivity management operation, described in greater detail herein. In various embodiments, the dynamic workspace connectivity management operation may be performed to orchestrate the connectivity between two or more workspaces and their corresponding hybrid container environments ‘1’ 402 through ‘n’ 404. In various embodiments, the dynamic workspace connectivity management operation may be performed to orchestrate the connectivity between a particular workspace and a non-workspace component of the dynamic workspace connectivity management environment 400, such as an access point, a router, a networked peripheral, and so forth.

In various embodiments, the dynamic workspace connectivity management operation may be performed to select a connectivity option (e.g., wired, wireless, etc.) that offers the best speed, efficiency, reliability, or security, or a combination thereof, for a particular workspace. In certain of these embodiments, such connectivity options may be defined by a workspace configuration policy stored in a repository of policy data 450. In certain of these embodiments, the dynamic workspace connectivity management operation may be performed according to the workspace configuration policy corresponding to a particular workspace. In certain embodiments, SW service ‘D’ 448 may be implemented to orchestrate two or more dynamic workspace connectivity management operations respectively performed by one or more ICS's 118 associated with a particular hybrid container environment ‘1’ 402 through ‘n’ 404.

In certain embodiments, SW service ‘A’ 434 may be implemented to submit a request to SW service ‘D’ 448 to register its associated hybrid container environment ‘1’ 404 through ‘n’ 404. In certain embodiments, SW service ‘D’ 448 may be implemented to perform such registration, and once it has done so, search the repository of policy data 450 for workspace configuration policies corresponding to the hybrid container environment ‘1’ 404 through ‘n’ 404. In certain embodiments, SW service ‘D’ 448 may be implemented to provide any such workspace configuration policies to SW service ‘A’ 434.

In various embodiments, SW service ‘A’ 434 may be implemented to receive any such workspace policies and then use them to respectively configure SW services ‘B’ 436, 438, respectively implemented within SW containerized environment 314 and HW containerized environment 334. In certain od these embodiments, SW service ‘A’ 434 may be implemented to perform secure inter-process communications (IPC) operations to discover the communications capabilities of SW containers ‘1’ 318 through ‘n’ 324 and HW containers ‘1’ 338 through ‘n’ 344. In various embodiments, SW service ‘A’ 434 may likewise be implemented to receive such workspace policies and use them to configure SW service ‘C’ 440. In certain embodiments, such configuration may include configuring peer-t-peer (P2P) network port identifiers (IDs), other network stack information, and platform communication capabilities. In certain embodiments, SW service ‘C’ 440 may be implemented as a kernel mode driver (KMD), familiar to skilled practitioners of the art. In certain embodiments, SW service ‘A’ 434 may be implemented to interface SW service ‘C’ 440 through a UEFI moderator 442, likewise familiar to those of skill in the art.

In certain embodiments, SW service ‘A’ 434 may be implemented to receive ongoing, steady state context from SW services ‘B’ 436, 438 related to applications executing in of SW containers ‘1’ 318 through ‘n’ 324 and HW containers ‘1’ 338 through ‘n’ 344, as well as wireless communication stack telemetry associated with SW service ‘C’ 440. In various embodiments, SW service ‘A’ 434 may be implemented to use certain telemetry received from SW services ‘B’ 436, 438, and ‘C’ 440, to make decisions related to adjusting P2P connections between two or more workspaces. Examples of such decisions include accommodating bandwidth limitations corresponding to a particular network link, Quality of Service (QoS) objectives, and network link aggregation.

In various embodiments, SW services ‘B’ 436, 438 and ‘C’ 440 may be implemented to receive certain workspace configuration policy information from SW service ‘A’ 434. In certain of these embodiments, SW services ‘B’ 436, 438 and ‘C’ 440 may be implemented to use such workspace configuration policy information to determine which containerized applications or processes to monitor, which communication settings and security parameters to set, and so forth. In various embodiments, SW services ‘B’ 436, 438 and ‘C’ 440 may be implemented to provide certain telemetry to SW service ‘A’ 434.

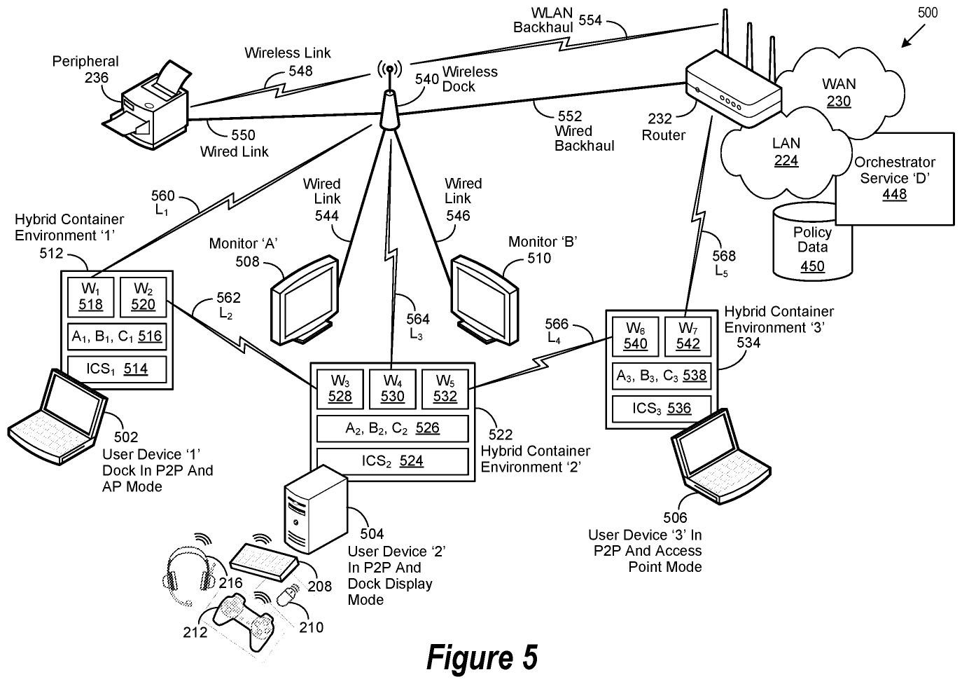

FIG. 5 shows a simplified block diagram of the performance of dynamic workspace connectivity management operations implemented in accordance with an embodiment of the invention. In certain embodiments, a router 232, familiar to skilled practitioners of the art, may be implemented to provide network connectivity to a Local Area Network (LAN) 224, or a Wide Area Network (WAN) 230, or both. In certain embodiments, a wireless dock 540, familiar to those of skill in the art, may be implemented to establish network connectivity with the router 232 via a wired 550 backhaul connection (e.g., an Ethernet connection), or one or more Wireless Local Area Network (WLAN) 552 backhaul connections.

In certain embodiments, the wireless dock 540 may likewise be implemented to respectively provide user devices ‘1’ 502 and ‘2’ 504 wireless access to the LAN 224, or the WAN 230, or both, via Wireless Local Area Network (WLAN) links L₁ 554 and L₃ 558. In certain embodiments, the router 232 may be implemented to provide user device ‘3’ 506 access to the LAN 224, or the WAN 230, or both, via a WLAN link L₅ 562. Likewise, in certain embodiments, WLAN links L₂ 556 and L₄ 560 may respectively be implemented to provide user device ‘2’ 522 peer-to-peer connections to user devices ‘1’ 502 and ‘3’ 506.

Likewise, in certain embodiments, the wireless dock 540 may be implemented to establish one or more network links to one or more peripherals 236, such as a printer, via a wired 548 network link, or one or more WLAN 546 links, or a combination thereof. In certain embodiments, the wireless dock 540 may be implemented to respectively provide a connection to one or peripherals, such as monitors ‘A’ 508 and ‘B’ 510 via wired connections 542 and 544. Examples of such wired connections 542 and 544 include a Universal Serial Bus (USB) connection, an IEEE 1394 connection, a Digital Visual Interface (DVI) connection, a DisplayPort connection, a High-Definition Multimedia Interface (HDMI) connection, and so forth. In certain embodiments, the wireless dock 540 may likewise be implemented to provide one or more Personal Area Network (PAN) links with one or more input/output (I/O) devices, such as a keyboard 208, a mouse 210, a gaming controller 212, a headset 216, and so forth.

In various embodiments, an orchestrator service ‘D’ 448, described in greater detail herein, may be implemented to manage certain workspace configuration policies, likewise described in greater detail herein, stored in a repository of policy data 450. In certain of these embodiments, the router 232 may be implemented to provide connectivity to the orchestrator service ‘D’ 448 and the repository of policy data 450 via the LAN 224, or the WAN 230, or both. In various embodiments, hybrid container environments ‘1’ 512, ‘2’ 514, and ‘3’ 516 may respectively be implemented on user devices ‘1’ 502, ‘2’ 504, and ‘3’ 506. In certain of these embodiments, the hybrid container environment ‘1’ 512 may be implemented with intelligent connectivity system ICS₁ 514 and software services A₁, B₁, and C₁ 516, as described in greater detail herein. Likewise, the hybrid container environment ‘2’ 522 may be implemented with ICS₂ 524 and software services A₂, B₂, and C₂ 526, while the hybrid container environment ‘3’ 534 may be implemented with ICS₃ 536 and software services A₃, B₃, and C₃ 538.

In various embodiments, ICS₁ 514 may be implemented to use software services A₁, B₁, C₁ 516 and ‘D’ 448, in combination with certain policy data 450, to perform one or more dynamic workspace connectivity management operations to manage connectivity for workspaces W₁ 518 and W₂ 520. In various embodiments, ICS₂ 524 may likewise be implemented to use software services A₁, B₁, C₁ 526 and ‘D’ 448, in combination with certain policy data 450, to perform one or more dynamic workspace connectivity management operations to manage connectivity for workspaces W₃ 528, W₄ 530 and W₅ 532. Likewise, in various embodiments, ICS₃ 536 may be implemented to use software services A₁, B₁, C₁ 538 and ‘D’ 448, in combination with certain policy data 450, to perform one or more dynamic workspace connectivity management operations to manage connectivity for workspaces W₆ 540 and W₇ 542.

For example, as described in greater detail herein, ICS₁ 514 may be implemented to use software service A₁ 516 to register user device ‘1’ 502 with orchestrator service ‘D’ 448. Once user device ‘1’ 502 is registered, its corresponding workspace configuration policy is retrieved from the repository of policy data 450 and provided to ICS₁ 514. In turn, the workspace configuration policy for user device ‘1’ 502 is provided to software services A₁, B₁, and C₁ 516 by ICS₁ 514. To continue the example, as shown in FIG. 5, the workspace configuration policy may then be used by ICS₁ 514 to manage connectivity between workspace W₁ 518 and wireless dock 540 via WLAN link L₁ 560. Likewise, the workspace configuration policy may be used by ICS₁ 514 to manage connectivity between workspace W₂ 520 and W₃ 528 via WLAN link L₂ 562.

To continue the example further, ICS₂ 514 may be implemented to use software service A₂ 526 to register user device ‘2’ 504 with orchestrator service ‘D’ 448. Once user device ‘2’ 504 is registered, its corresponding workspace configuration policy is retrieved from the repository of policy data 450 and provided to ICS₂ 524. In turn, the workspace configuration policy for user device ‘2’ 504 is provided to software services A₂, B₂, and C₂ 526 by ICS₂ 526. To further continue the example, the workspace configuration policy may then be used by ICS₂ 526 to manage connectivity between workspace W₄ 530 and wireless dock 540 via WLAN link L₃ 564. Likewise, the workspace configuration policy may be used by ICS₂ 526 to respectively manage connectivity between workspaces W₂ 520 and W₃ 528 via WLAN link L₂ 562 and workspaces W₅ 532 and W₆ 540 via WLAN link L₄ 566.

To continue the example yet further, ICS₃ 536 may be implemented to use software service A₃ 538 to register user device ‘3’ 506 with orchestrator service ‘D’ 448. Once user device ‘3’ 506 is registered, its corresponding workspace configuration policy is retrieved from the repository of policy data 450 and provided to ICS₃ 536. As before, the workspace configuration policy for user device ‘3’ 506 is provided to software services A₃, B₃, and C₃ 538 by ICS₃ 536. In further continuance of the example, the workspace configuration policy may then be used by ICS₃ 536 to manage connectivity between workspace W₇ 542 and the router 234 via WLAN backhaul link L₅ 568. Likewise, the workspace configuration policy may be used by ICS₃ 536 to manage connectivity between workspaces W₅ 532 and W₆ 540 via WLAN link L₄ 566.

In certain embodiments, ICS₁ 514 and ICS₂ 516 may be implemented to work in combination to collaboratively manage workspace connectivity between workspaces W₂ 520 and W₃ 528 via WLAN link L₂ 562. Likewise, ICS₂ 516 and ICS₃ 526 may be implemented in certain embodiments to work in combination to collaboratively manage workspace connectivity between workspaces W₅ 532 and W₆ 540 via WLAN link L₄ 566.

To add context to the preceding example, workspace W₂ 518 may include a videoconferencing session via WLAN link L₁ 560 to the wireless dock 540, while workspaces W₂ 520 and W₃ 528 may include a peer-to-peer (P2P) messaging session between user devices ‘1’ 502 and ‘2’ 504. To add additional context, workspace W₄ 530 may include display of the same videoconferencing session on monitors ‘A’ 508 and ‘B’ 510 via WLAN link L₃ 564 to the wireless dock 540, and from there, via wired links 544 and 546, while workspaces W₅ 532 and W₆ 540 may include a P2P messaging session between user devices ‘2’ 504 and ‘3’ 506. To add yet additional context, workspace W₇ 542 may include participation in the same videoconferencing session via WLAN backhaul link L₅ 568 to the router 232.

From the foregoing, skilled practitioners of the art will recognize that implementation of such dynamic workspace connectivity operations will likely result in more efficient use of available connectivity while isolating workspaces not only between different user devices, but within individual user devices as well. Accordingly, certain dynamic workspace connectivity management operations, as described in greater detail herein, may be implemented to optimize the use of available network links while improving workspace security. Those of skill in the art will recognize that many such embodiments are possible. Accordingly, the foregoing is not intended to limit the spirit, scope, or intent of the invention.

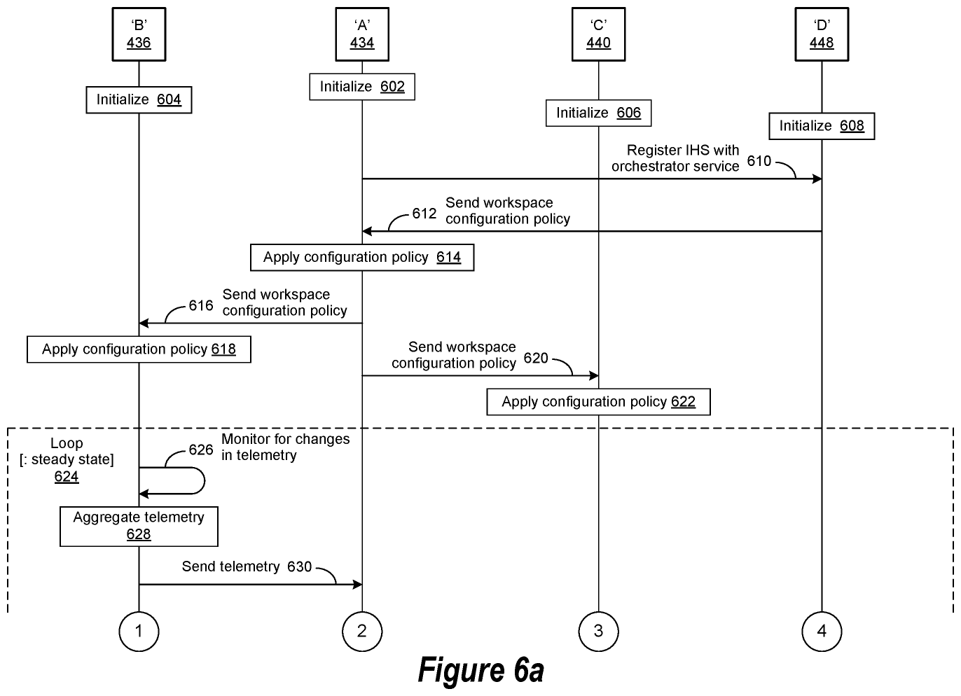

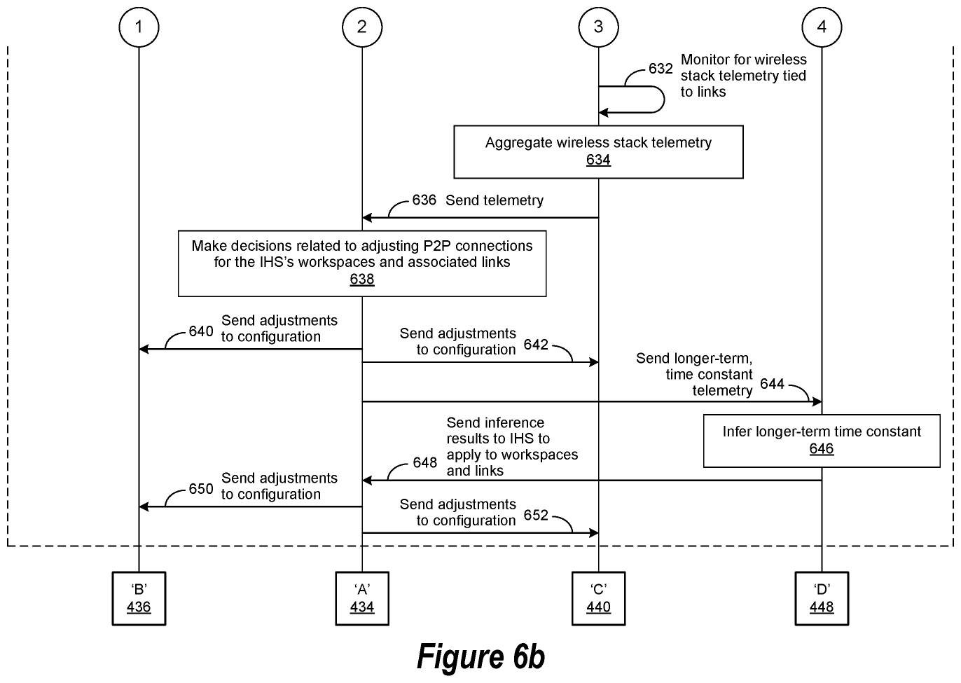

FIGS. 6a and 6b show process flows associated with the performance of dynamic workspace connectivity management operations implemented in accordance with an embodiment of the invention. In certain embodiments, software services ‘B’ 436, ‘A’ 434, and ‘C’ 440 may be implemented on an information handling system (IHS), while software service ‘D’ 446 may be implemented as a cloud-based orchestrator service, as described in greater detail herein. In this embodiment, dynamic workspace connectivity management operations are begun by software services ‘B’ 436, ‘A’ 434, ‘C’ 440, and ‘D’ 446 being sequentially initialized in steps 602, 604, 606, and 608.

Then, in step 610, software service ‘A’ 434 registers its associated IHS with software service ‘D’ 448. Once the IHS has been registered, software service ‘D’ 448 sends a corresponding workspace configuration policy, described in greater detail herein, to software service ‘A’ 434 in step 612. Thereafter, software service ‘A’ 434 applies the workspace configuration policy to itself in step 614, after which it sends it to software service ‘B’ 436 in step 616. Once software service ‘B’ 436 receives the workspace configuration policy, it applies it to itself in step 618. Afterwards, software service ‘A’ 434 the workspace configuration policy to software service ‘C’ 440 in step 620, which then applies it to itself in step 622.

Ongoing steady-state loop operations 624 are then initiated, followed by software service ‘B’ 436 monitoring 626 changes in network traffic telemetry. As changes in network traffic telemetry occur, they are aggregated by software service ‘B’ in step 628 and then sent to software service ‘A’ 434 in step 630. Concurrently, software service ‘C’ 440 likewise monitors 632 for changes in network traffic telemetry, and as they occur, aggregates them in step 634, followed by sending the aggregated changes to software service ‘A’ 434 in step 636.

The aggregated changes in network traffic telemetry received from software services ‘B’ 436 and ‘C’ 440 are then used by software service ‘A’ 434 in step 638 to make decisions related to adjusting peer-to-peer (P2P) connections for the IHS's workspaces and associated network links, described in greater detail herein. Any configuration adjustments are then respectively sent by software service ‘A’ 434 to software services ‘B’ 436 and ‘C’ 440 in steps 640 and 642. Thereafter, software service ‘A’ 434 sends longer-term, time constant network traffic telemetry to software service ‘D’ 448 in step 644, where it is used in step 646 to infer future longer-term, time constant network traffic telemetry. The results of the inferences are then sent to software service ‘A’ 434 in step 648, which then uses it in steps 650 and 652 to respectively make configuration adjustments to software services ‘B’ 436 and ‘C’ 440.

As will be appreciated by one skilled in the art, the present invention may be embodied as a method, system, or computer program product. Accordingly, embodiments of the invention may be implemented entirely in hardware, entirely in software (including firmware, resident software, micro-code, etc.) or in an embodiment combining software and hardware. These various embodiments may all generally be referred to herein as a “circuit,” “module,” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example, but not limited to, an electronic, magnetic, optical, electromagnetic, infrared, or semiconductor system, apparatus, or device. More specific examples (a non-exhaustive list) of the computer-readable medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, or a magnetic storage device. In the context of this document, a computer-usable or computer-readable medium may be any medium that can contain, store, communicate, or transport the program for use by or in connection with the instruction execution system, apparatus, or device.

Computer program code for carrying out operations of the present invention may be written in an object oriented programming language such as JAVA, SMALLTALK, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

Embodiments of the invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

Consequently, the invention is intended to be limited only by the spirit and scope of the appended claims, giving full cognizance to equivalents in all respects.

What is claimed is:

1. A computer-implementable method for performing an intelligent connectivity operation, comprising:
implementing a first hybrid container environment on a first user device, the first hybrid container environment comprising a plurality of first hybrid container environment workspaces;
implementing a second hybrid container environment on a second user device, the second hybrid container environment comprising a plurality of second hybrid container environment workspaces; and,
performing a dynamic workspace connectivity management operation, the dynamic workspace connectivity management operation managing connectivity between one of the plurality of first hybrid container environment workspaces and one of the plurality of second hybrid container environment workspaces.

2. The method of claim 1, further comprising:
implementing an orchestrator service, the orchestrator service maintaining a workspace configuration policy.

3. The method of claim 1, wherein:
the first hybrid container environment comprises a first intelligent communication system;
the second hybrid container environment comprises a second intelligent communication system; and,
the first intelligent communication system and the second intelligent communication system perform the dynamic workspace connectivity management operation.

4. The method of claim 1, wherein:
the dynamic workspace connectivity operation provides secure communication between the one of the plurality of first hybrid container environment workspaces and the one of the plurality of second hybrid container environment workspaces.

5. The method of claim 1, wherein:
the first hybrid container environment comprises a software containerized environment and a hardware containerized environment.

6. The method of claim 1, wherein:
the connectivity between one of the plurality of first hybrid container environment workspaces and one of the plurality of second hybrid container environment workspaces comprises at least one of a Wireless Local Area Network link and a peer-to-peer link.

7. A system comprising:
a processor;
a data bus coupled to the processor; and
a non-transitory, computer-readable storage medium embodying computer program code, the non-transitory, computer-readable storage medium being coupled to the data bus, the computer program code interacting with a plurality of computer operations and comprising instructions executable by the processor and configured for:
implementing a first hybrid container environment on a first user device, the first hybrid container environment comprising a plurality of first hybrid container environment workspaces;
connecting the first hybrid container environment with a second hybrid container environment on a second user device, the second hybrid container environment comprising a plurality of second hybrid container environment workspaces; and,
performing a dynamic workspace connectivity management operation, the dynamic workspace connectivity management operation managing connectivity between one of the plurality of first hybrid container environment workspaces and one of the plurality of second hybrid container environment workspaces.

8. The system of claim 7, wherein the instructions executable by the processor are further configured for:
implementing an orchestrator service, the orchestrator service maintaining a workspace configuration policy.

9. The system of claim 7, wherein:
the first hybrid container environment comprises a first intelligent communication system;
the second hybrid container environment comprises a second intelligent communication system; and,
the first intelligent communication system and the second intelligent communication system perform the dynamic workspace connectivity management operation.

10. The system of claim 7, wherein:
the dynamic workspace connectivity operation provides secure communication between the one of the plurality of first hybrid container environment workspaces and the one of the plurality of second hybrid container environment workspaces.

11. The system of claim 7, wherein:
the first hybrid container environment comprises a software containerized environment and a hardware containerized environment.

12. The system of claim 7, wherein:
the connectivity between one of the plurality of first hybrid container environment workspaces and one of the plurality of second hybrid container environment workspaces comprises at least one of a Wireless Local Area Network link and a peer-to-peer link.

13. A non-transitory, computer-readable storage medium embodying computer program code, the computer program code comprising computer executable instructions configured for:
implementing a first hybrid container environment on a first user device, the first hybrid container environment comprising a plurality of first hybrid container environment workspaces;
implementing a second hybrid container environment on a second user device, the second hybrid container environment comprising a plurality of second hybrid container environment workspaces; and,
performing a dynamic workspace connectivity management operation, the dynamic workspace connectivity management operation managing connectivity between one of the plurality of first hybrid container environment workspaces and one of the plurality of second hybrid container environment workspaces.

14. The non-transitory, computer-readable storage medium of claim 13, wherein the computer executable instructions are further configured for:
implementing an orchestrator service, the orchestrator service maintaining a workspace configuration policy.

15. The non-transitory, computer-readable storage medium of claim 13, wherein:
the first hybrid container environment comprises a first intelligent communication system;
the second hybrid container environment comprises a second intelligent communication system; and,
the first intelligent communication system and the second intelligent communication system perform the dynamic workspace connectivity management operation.

16. The non-transitory, computer-readable storage medium of claim 13, wherein:
the dynamic workspace connectivity operation provides secure communication between the one of the plurality of first hybrid container environment workspaces and the one of the plurality of second hybrid container environment workspaces.

17. The non-transitory, computer-readable storage medium of claim 13, wherein:
the first hybrid container environment comprises a software containerized environment and a hardware containerized environment.

18. The non-transitory, computer-readable storage medium of claim 17, wherein:
the connectivity between one of the plurality of first hybrid container environment workspaces and one of the plurality of second hybrid container environment workspaces comprises at least one of a Wireless Local Area Network link and a peer-to-peer link.

19. The non-transitory, computer-readable storage medium of claim 13, wherein:
the computer executable instructions are deployable to a client system from a server system at a remote location.

20. The non-transitory, computer-readable storage medium of claim 13, wherein:
the computer executable instructions are provided by a service provider to a user on an on-demand basis.
